(19) United States
(12) Patent Application Publication
(10) Pub. No.: US 2026/0323271 A1
(43) Pub. Date: Oct. 15, 2026

(54) CLIENT TRIGGERED PRE-ROAMING PREPARATION FOR SEAMLESS ROAMING

(71) Applicant: Cisco Technology, Inc., San Jose, CA (US)

(72) Inventors: Binita GUPTA, San Diego, CA (US); Brian D. HART, Sunnyvale, CA (US); Sudhir K. JAIN, Fremont, CA (US)

(21) Appl. No.: 19/465,856

(22) Filed: Jan. 30, 2026

Related U.S. Application Data
(60) Provisional application No. 63/754,445, filed on Feb. 5, 2025.

(51) Int. Cl. H04W 8/14; H04W 76/15

(52) U.S. Cl. CPC H04W 8/14; H04W 76/15

(57) ABSTRACT

A client (e.g., a non-AP MLD) can request that a currently serving AP MLD prepare neighboring AP MLDs with roaming context that facilitates a future direct roam by the client. The currently serving AP MLD (or a WLC) can select which neighboring AP MLDs to prepare, or the client can provide a list of neighboring AP MLDs to prepare. The currently serving AP can then provide roaming context corresponding to the client to the selected neighboring AP MLDs (e.g., a client identifier, encryption keys, etc.). Once prepared, the currently serving AP MLD can provide a list of the neighboring AP MLDs that now have the roaming context to the client. Later, when the client decides it should perform a direct roam, the client can select (or give priority to) the neighboring AP MLDs in the list.

### CROSS-REFERENCE TO RELATED APPLICATIONS

This application claims benefit of co-pending United States provisional patent application Serial No. 63/754,445 filed Feb. 5, 2025. The aforementioned related patent application is herein incorporated by reference in its entirety.

### TECHNICAL FIELD

Embodiments presented in this disclosure generally relate to preparing target APs for future direct roams by a client in a seamless mobility domain (SMD).

### BACKGROUND

IEEE 802.11bn (Wi-Fi 8) has proposed to support seamless roaming within an SMD. The SMD includes multiple access point (AP) multi-link devices (MLDs) and one or more clients/non-AP MLDs that associate with an SMD management entity (SMD-ME) of the SMD. The SMD-ME is an SMD-level component that provides SMD level authentication, association and key management functions, and can be implemented on the AP MLDs (in a distributed implementation) or on a controller for the SMD (in a centralized implementation). The client can roam or transition between AP MLDs of the SMD without performing reassociation. In some implementations, the client establishes a single PMKSA (Pairwise Master Key Security Association) and a single PTKSA (PTK Security Association) with the SMD-ME.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a system where a non-AP MLD requests a serving AP MLD to prepare neighboring AP MLDs for a future direct roam by the client, according to one embodiment.

FIG. 2 is a flowchart for preparing neighboring AP MLDs for a future direct roam, according to one embodiment.

FIG. 3 is a flowchart for performing a direct roam, according to one embodiment.

FIG. 4 is a flowchart for preparing neighboring AP MLDs for a future direct roam after performing a roam in a SMD, according to one embodiment.

FIG. 5 depicts an example computing device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a method that includes receiving, at a currently serving access point (AP), a request from a non-AP device to prepare one or more target APs for a future direct roam of the non-AP device directly to one of the one or more target APs where the one or more target APs and the currently serving AP are in a same seamless mobility domain (SMD) and transmitting, before the non-AP device has requested to roam to one of the one or more target APs and after receiving the request, roaming context associated with the non-AP device to the one or more target APs.

One embodiment presented in this disclosure is an AP that includes one or more memories and one or more processors communicatively coupled to the one or more memories, wherein the one or more processors are configured, individually or collectively, to perform an operation. The operation includes receiving a request from a non-AP device to prepare one or more target APs for a future direct roam of the non-AP device directly to one of the one or more target APs where the one or more target APs and the AP are in a same SMD and transmitting, before the non-AP device has requested to roam to one of the one or more target APs and after receiving the request, roaming context associated with the non-AP device to the one or more target APs.

One embodiment presented in this disclosure is non-transitory computer readable medium storing instructions that, when executed by one or more processors in a currently serving AP, cause the one or processors to, individually or collectively, perform an operation. The operation includes receiving, at the currently serving AP, a request from a non-AP device to prepare one or more target APs for a future direct roam of the non-AP device directly to one of the one or more target APs where the one or more target APs and the currently serving AP are in a same SMD and transmitting, before the non-AP device has requested to roam to one of the one or more target APs and after receiving the request, roaming context associated with the non-AP device to the one or more target APs.

### EXAMPLE EMBODIMENTS

In an optimal execution of seamless roaming (also referred to as an SMD BSS transition (ST)), the client performs roaming preparation and a roaming execution procedure through the AP MLD that is currently serving the client (referred to herein as the “currently serving AP MLD” or “serving AP MLD”). However, there can be scenarios where the client’s Received Signal Strength Indicator (RSSI) to the currently serving AP MLD drops suddenly, or the client was in a power save state, and when waking up from this state, its RSSI to the currently serving AP MLD has dropped. In these scenarios, instead of roaming through the currently serving AP MLD, the client performs ST roaming directly through a target AP MLD that the client selects.

To perform seamless roaming with a target AP MLD, it is advantageous to prepare the target AP MLD by providing roaming context about the client in advance. This client roaming context can enable the target AP MLD to identify the client when it receives a direct roaming request from the client. For example, the client context can include an identifier for the client (e.g., a non-AP MLD MAC address, a STA MAC address, a one-time roaming MAC address, a Pairwise Master Key Identifier (PMKID)), a PMKSA established for the client with the SMD (that includes a PMK and/or an SMD level roaming key), and a PTKSA established for the client with the SMD (that includes a SMD level shared PTK) and other client context. If the target AP MLD is not prepared with the client context, then the target AP MLD may reject the roaming request directly sent to the target AP MLD since the non-AP MLD cannot be identified, or the target AP MLD may have to fetch the client context from another network node (e.g., a wireless LAN controller (WLC) or a network key store). This can add to the roaming delay and could also open up a path for denial of service (DoS) attacks. Hence, it is advantageous to provide client roaming context to neighboring AP MLDs before the client roams to enable faster direct roaming and potentially avoid DoS attacks.

The embodiments herein provide techniques for the client to explicitly trigger such preparation and also be notified of which neighboring AP MLDs have been prepared by the currently serving AP MLD. The client can use this information to intelligently select a target AP for direct roaming.

In one embodiment, the AP MLDs in an SMD may advertise to the clients if the APs in the SMD have the capability of preparing neighboring AP MLDs with client context for direct future roams. This capability can be advertised in Beacon, Probe Response, (Re)Association Response or another broadcast or individually addressed management frame as part of an SMD Information element or another UHR element or an existing element. If such a capability is announced, the client can request that the currently serving AP MLD prepare the neighboring AP MLDs. The currently serving AP MLD (or a WLC) can then select which neighboring AP MLDs to prepare, or the client can provide a list of neighboring AP MLDs to prepare, e.g., based on information in a neighboring report (NR). The currently serving AP can then provide the client roaming context to the selected neighboring AP MLDs (e.g., a client identifier, encryption keys, etc.). In one embodiment, the AP MLD does not explicitly announce a capability for preparing neighbor AP MLDs for direct roaming and if seamless roaming is supported then this capability is also supported by the AP MLDs in the SMD.

Once prepared, the currently serving AP MLD can provide a list of the neighboring AP MLDs that now have the roaming context to the client. Later, when the client decides it has to perform a direct roam, it can select (or give priority to) the neighboring AP MLDs on the list since these APs are less likely to reject the roaming request (because they can identify the client) and the roaming delay may be shorter relative to roaming to a neighboring AP that was not prepared in advance. After roaming to a new AP MLD in the SMD, the process can repeat where the client instructs the new serving AP MLD to prepare neighboring APs with the roaming context in preparation for a future direct roam.

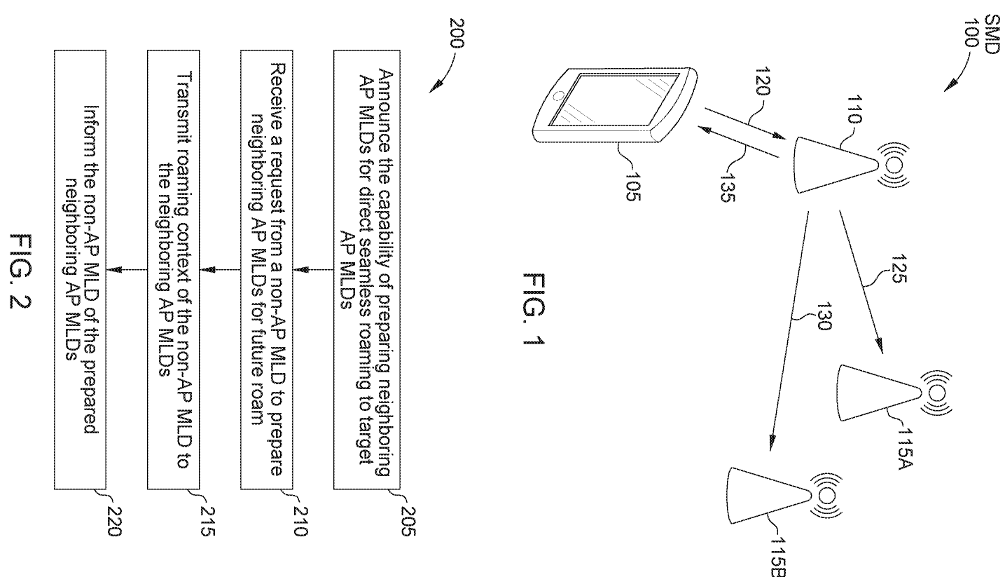

FIG. 1 is an SMD 100 where a client 105 requests a serving AP MLD 110 to prepare neighboring AP MLDs 115 for a future direct roam by the client 105, according to one embodiment. In one embodiment, as part of the client 105 (e.g., a non-AP MLD or a non-AP device) associating to the SMD-ME of SMD 100 via the serving AP MLD 110, the client 105 issues a request 120 to the serving AP MLD 110 to prepare at least one neighboring AP MLD 115 with roaming context in anticipation that the client 105 may in the future perform a direct roam to one of the neighboring AP MLDs 115. As discussed in more detail below, the client 105 may provide a list of neighboring AP MLDs to prepare, or the AP MLD 110 (or a WLC) may select the neighboring AP MLDs, or both the client 105 and the AP MLD 110 may select the neighboring AP MLDs to prepare.

In this example it is assumed that both of the neighboring AP MLDs 115 have been selected to receive the roaming context for the client 105. As shown, the serving AP MLD 110 transmits the client roaming context to both AP MLD 115A and 115B as represented by arrows 125 and 130. This roaming context can include an identifier for the client 105 (e.g., a non-AP MLD MAC address, a STA MAC address, a one-time roaming MAC address, a PMKID, etc.) and a PMKSA established for the client 105 with the SMD 100 (that includes a PMK and/or an SMD level roaming key), a PTKSA established for the client with the SMD (that includes a SMD level shared PTK) and other client context.

Once the roaming context is successfully transferred, the currently serving AP MLD 110 can transmit a list 135 of the neighboring AP MLDs 115 that now have the roaming context to the client 105 (referred to herein as “prepared neighboring AP MLDs”). The client 105 can use this list to make intelligent roaming decisions as discussed next. In one embodiment, this list 135 can indicate that all (or most) neighboring AP MLDs in the SMD are prepared with client’s roaming context (e.g. using a field indicating this), instead of providing specific set of target AP MLDs (e.g., without providing a complete list of each of the target AP MLDs that were prepared). For example, this can be done if the list includes a large number of prepared target AP MLDs (e.g., once 50 or more target APs have been prepared).

Although not shown in FIG. 1, the client device 105 may decide, due to special circumstances (e.g., a sudden drop in RSSI), that it should roam directly though one of the neighboring AP MLDs 115A and 115B, rather than roaming through the currently serving AP MLD 110. Absent these circumstances, the client 105 would roam to one of the neighboring AP MLDs 115 through the currently serving AP MLD 110. For example, the client 105 can start the roaming process by transmitting a roaming preparation request to the serving AP MLD 110 to roam to one of the neighboring AP MLDs 115. However, if the client 105 can longer reliably communicate with the serving AP MLD 110, it has to roam directly through the target AP. In that case, the client 105 selects one of the neighboring AP MLDs 115 as the target AP and transmits a roaming request directly to the target AP. The client 105 can use the list 135 to select a target AP that has been prepared with its roaming context (or at least give more weight to neighboring APs that have been prepared). This can result in a direct roam that is more likely to succeed, and with less roaming delay.

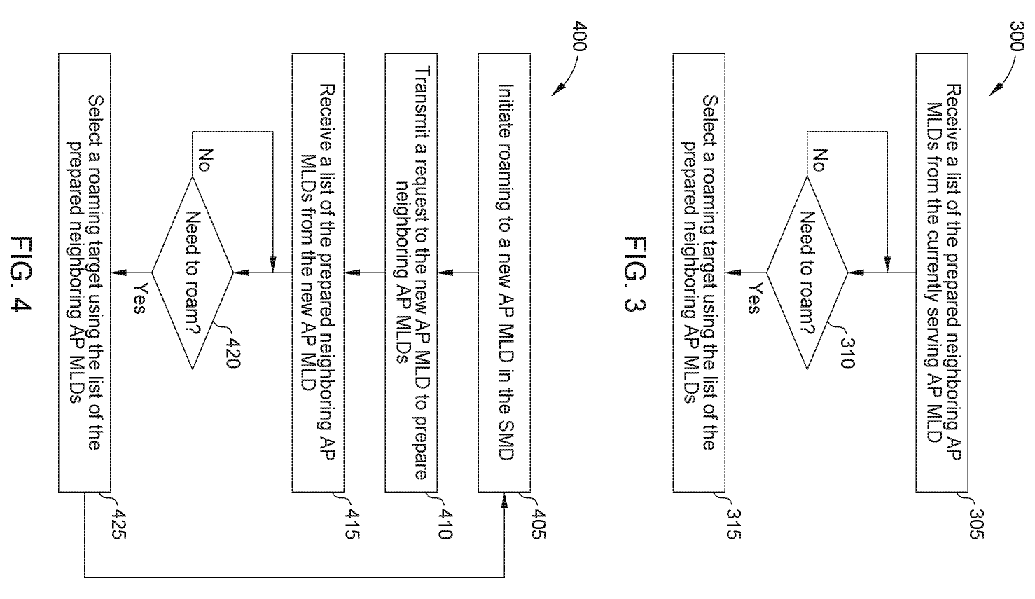

FIG. 2 is a flowchart of a method 200 for preparing neighboring AP MLDs for a future direct roam, according to one embodiment. At block 205, the currently serving AP MLD announces the capability of preparing neighboring AP MLDs for seamless roaming for performing a direct roam. The AP MLD can announce this capability in an SMD Information element or in another ultra-high reliability (UHR) element or an existing element in a Beacon, Probe Response, (Re)Association Response or another broadcast or individually addressed management frame.

However, block 205 may be optional, or may not be performed in some embodiments. For example, if the SMD conforms to a wireless standard (e.g., an IEEE standard) which requires the AP MLDs to have the capability to prepare neighboring AP MLDs for future direct roams, then the APs may not advertise this capability since it is assumed all APs in the SMD have this capability, e.g., if seamless roaming is supported.

At block 210, the currently serving AP MLD receives a request from a non-AP MLD (or client) to prepare neighboring AP MLDs for a future direct roam. That is, the client can trigger the preparation, rather than the currently serving AP MLD performing the preparation on its own (or being triggered by a WLC in the SMD).

In one embodiment, as part of its initial association with the SMD (e.g., during an association exchange), the client signals to the serving AP MLD that it would like to initiate preparing neighboring AP MLDs with the client’s roaming context. For instance, the client may transmit the request only if the currently serving AP MLD announces that it supports this capability as described in block 205.

There are several options for the client to transmit a request to the currently serving AP MLD. In one option, the request is provided in a (Re)Association Request frame as part of an SMD element or part of another existing/new element. For example, in the (Re)Association request frame, the client can signal this request in the SMD Information element, e.g., a new field (e.g., ‘Prepare Neighboring APs for Direct SMD roaming”) can be defined in the SMD Information element. This is set to 1 by the client to signal this request to the serving AP MLD.

In another option, the request for the serving AP to prepare the neighboring AP MLDs for a future direct roam can be signaled in an element or field in Message 4 of the 4-way handshake in a secure way.

In yet another option, this request can be signaled in another management frame (existing or new), e.g. as part of an SMD element or part of another existing /new element.

In one embodiment, a new field or bit can be defined that gets set to 1 by the client to signal the request to prepare neighboring APs. This new field can be defined in the SMD Information element or another existing or new element. If the currently serving AP MLD determines it will prepare neighboring APs/AP MLDs as requested, then it can signal its acceptance of the request in the corresponding response frame (e.g. the (Re)Association Response frame or another management frame sent in response).

In one embodiment, the set of neighboring AP MLDs that are prepared for the future direct roam is determined by the network (e.g., the currently serving AP MLD or the WLC).

In another embodiment, the client provides a list of neighboring AP MLDs that the client wants to prepare for direct SMD roaming (e.g. a set of client preferred APs) in the request (using any of the options above). For example, the client can include one or more Neighbor Report elements in the request or include one or more multi-link (ML) elements (e.g. Basic ML element) indicating neighboring AP MLDs that the client wants prepared.

When a list of neighboring AP MLDs are provided by the client, the serving AP MLD can give preference to preparing those AP MLDs. In one embodiment, the serving AP MLD can decide to prepare all or a subset of the neighboring AP MLDs requested by the client. In addition, the serving AP MLD can determine to prepare the AP MLDs requested by the client as well as prepare other AP MLDs that were not requested by the client for direct ST roaming.

At block 215, the currently serving AP transmits the roaming context of the non-AP MLD (client) to the neighboring AP MLDs. These can be the neighboring AP MLDs that were selected by the network (e.g., the currently serving AP MLD and/or the WLC), the neighboring AP MLDs selected by the client, or both.

In one embodiment, the roaming context includes static (rather than dynamic) context regarding the client. The static roaming context can include one or more of a Roaming MAC Address intended for use at next roaming (or other identifiers for the client), a PMKID identifying the PMK established with the SMD for the client, a PMKSA (including PMK) for the PMK established with the SMD for the client, an SMD level roaming key (e.g., as part of PMKSA) used for sending encrypted roaming request for direct roam to target AP (or a PTKSA (including PTK) if a shared PTK is used across all AP MLDs of the SMD for the client (i.e., if the client uses the same PTK for securely communicating with each AP MLD in the SMD when roaming between different AP MLDs)), and other static client context.

In one embodiment, the serving AP MLD also prepares the neighboring AP MLDs with the PTKSA, and whenever the shared PTK is rekeyed, the serving AP MLD sends the updated PTKSA to those neighboring AP MLDs. However, in another embodiment, the serving AP MLD does not send the PTKSA in the roaming context since PTK can change with rekeying. Instead, the serving AP MLD may only send other roaming context such as client identifier(s), PMKSA etc. In that case, when a roam is initiated by the client, the target AP can fetch the PTK/PTKSA from the WLC or a key store, assuming the target AP was able to identify the client using the roaming context received at block 215.

While the roaming context could include dynamic roaming context associated with the client, it may be advantageous to only transmit static roaming context at block 215. For example, dynamic roaming context can include block acknowledgement context with the current serving AP MLD, or stream classification service (SCS) agreements which are set up between the currently serving AP MLD and the client. While this dynamic roaming context can be shared when a roam in an SMD is triggered, transmitting dynamic roaming context in preparation for a roam (as discussed in method 200) can waste memory and cause the neighboring AP MLDs to reserve resources for a roam which may never happen. As such, in some embodiments, the roaming context transferred at block 215 may be static (or close to static) client context which generally does not change (or changes infrequently) as the client roams between AP MLDs in the SMD.

At block 220, the currently serving AP informs the non-AP MLD (the client) of the prepared neighboring AP MLDs. For example, the serving AP MLD can send a notification frame to the client notifying the client of the set of neighboring AP MLDs that were prepared. In one embodiment, the serving AP can use a management frame or an action frame that provides the list of neighbor APs that have been prepared. This frame could include a list of Neighbor Report elements or a list of ML elements that indicate set of prepared neighboring AP MLDs.

In another embodiment, the serving AP uses an existing frame such as the Neighbor Report Response frame, BSS transition management (BTM) Request frame, or Link Reconfiguration Notify frame to indicate the list of neighboring AP MLDs that have been prepared for seamless roaming.

In yet another embodiment, the serving AP MLD sends a UHR Link Reconfiguration Notify frame to the client, with a new Type value, that provides a list of Neighboring AP MLDs that are prepared for the direct ST roaming. The frame can include a list of Neighbor Report elements or a list of Basic ML elements to provide information for prepared neighboring AP MLDs. The new type value in the frame can indicate that the frame is providing a list of prepared neighboring AP MLDs for direct SMD roaming.

Additionally, in any of the options, a reason code can be provided in the frame to indicate that the frame is providing list of prepared target AP MLDs for direct SMD roaming.

FIG. 3 is a flowchart of method 300 for performing a direct roam, according to one embodiment. At block 305, the client (e.g., a non-AP MLD) receives a list of the prepared neighboring AP MLDs from the currently serving AP MLD. This list can be transmitted to the client using any of the techniques discussed above in block 220 of method 200. Advantageously, by receiving a list of neighboring AP MLDs that have the client’s roaming context enables the client to make more intelligent roaming decisions as discussed in method 300.

At block 310, the client determines whether it should roam. More specifically, the embodiments herein describe when the client decides it should perform a direct roam to a target AP in a SMD, rather than performing a roam through its currently serving AP MLD. As mentioned above, there can be scenarios where the client’s RSSI to the currently serving AP MLD drops suddenly, or the client was in a power save state and when waking up from this state its RSSI to the currently serving AP MLD has dropped. In these scenarios, instead of roaming through the currently serving AP MLD, the client performs ST roaming directly through a target AP MLD that the client selects.

After determining to perform a direct roam through a target AP, at block 315 the client selects a roaming target using the list of the prepared neighboring AP MLDs received at block 305. In one embodiment, the client selects the target AP from the list. In another embodiment, the client uses the list to weight candidate roaming targets. For example, two of the roaming candidate APs in the SMD may have a similar signal strength at the client, however, one of the APs may be in the list while the other is not. The client can select the AP that is on the list since the roam will more likely be successful and take less time. In another example, the client may have a much stronger signal strength to a candidate AP that is not on the list than each of the candidate APs that are on the list. In that case, the client may choose to perform direct roaming to the candidate AP not on the list. In other words, in some scenarios the client may choose to perform a direct roam to a target AP that is not in the list.

FIG. 4 is a flowchart of a method 400 for preparing neighboring AP MLDs for a future direct roam after performing a roam in an SMD, according to one embodiment. That is, method 300 may have already been performed where a client uses a list of prepared neighboring AP MLDs to select a target AP for performing a direct ST roam.

At block 405, the client initiates roaming to a new AP MLD in the SMD, which can be the roaming target selected at block 315 of method 300. In this embodiment, the request to prepare neighboring AP MLDs of the new AP MLD is sent as part of roaming exchange to the new AP MLD. The new AP MLD could also be a target AP MLD with which the client performs ST roaming procedure through currently serving AP MLD. Meaning the client can perform seamless roaming to the new AP MLD either by performing a direct ST roaming or by performing ST roaming through its serving AP MLD (by performing ST preparation and ST execution procedure).

At block 410, the client transmits a request to the new AP MLD to prepare neighboring AP MLDs for a future direct roam. This request can be sent using the same techniques discussed at block 210 of method 200. In one embodiment, the client can transmit the request for preparing neighboring AP MLDs for a direct roam to the new AP MLD, as part of roaming exchange performed to roam to that new AP MLD. For example, the client can send the request in the ST preparation request, the ST execution request, or the roaming request sent directly over-the-air to a target AP MLD (say an ST direct request). For example, when client roams to the new AP MLD through its currently serving AP MLD, it can send this request to prepare neighboring AP MLDs for a future direct roam in the ST preparation request or in the ST execution request sent to its currently serving AP MLD. The currently serving AP MLD transfers this request to the target AP MLD(s). The client can also send this request in a roaming request sent directly to the new AP MLD, e.g., in the ST execution request sent to the new AP MLD or in a roaming request sent to roam directly to the new AP MLD (e.g. ST direct request). Then the target AP MLD(s) would prepare neighboring AP MLDs for future direct roam by transferring roaming context as discussed in block 215. For example, as above, a ‘Prepare Neighboring APs for Direct SMD Roaming’ field/bit can be set by the client to signal its request to prepare neighboring APs. This new field can be defined in the SMD Information element or another existing or new element included in any of the roaming requests as described above. This field can be defined as part of the SMD BSS Transition Parameters element (e.g. in the ST Info field).

If the new AP MLD accepts the request to prepare neighboring APs/AP MLDs, then the AP can signal its acceptance in a corresponding roaming response frame (e.g. in the ST preparation response, the ST execution response or the ST direct response). For example, this can be signaled by a field/bit in the SMD element or another field/element or the SMD BSS Transition Parameters element. In one embodiment, there is no separate response sent to signal acceptance for preparing neighboring AP MLDs, and the new AP MLD always prepares set of neighboring AP MLDs if requested by the client (e.g., when AP MLDs in the SMD indicate capability for preparing neighboring AP MLDs for direct roaming as described in block 205).

In one embodiment, when roaming to the new AP MLD, the client signals to the new AP MLD that it would like to initiate preparing neighboring AP MLDs with the client’s roaming context. Alternatively, the client can transmit this request after completing the roaming process. In any case, the client can request the new AP MLD to prepare the neighboring AP MLDs before the client decides to perform another roam.

In response to receiving the request from the client, the new AP MLD transmits the roaming context of the client to the neighboring AP MLDs. These APs can be selected by the network (e.g., the new AP MLD and/or the WLC), or these APs can be selected by the client, or both.

At block 415, the client receives a list of the prepared neighboring AP MLDs from the new AP MLD. That is, the client receives a new list of the AP MLDs that have its roaming context. In one embodiment, the client replaces an old list received from the previous AP MLD with the new list received at block 415. However, in other embodiments, the client may store both the old and new lists. For example, the AP MLDs may store roaming context for a client for a defined time period, but if the client does not roam to them within that time period, the APs may delete the roaming context. Similarly, the client may maintain lists of prepared AP MLDs according to the same time period (or a time period determined by the client). Once that time period expires, the client may delete any lists containing APs that no longer store its roaming context. In one embodiment, along with the list of the prepared neighboring AP MLDs, the AP MLD may also provide this time period for which roaming context will be maintained at those prepared neighboring AP MLDs. Then the client can use this time period to decide when to expire the list of prepared neighboring AP MLDs.

At block 420, the client determines whether it should perform a roam. Like in method 300, the method 400 assumes the client decides whether to perform a direct roam to a target AP in a SMD, rather than performing a roam through its currently serving AP MLD. For example, this may be because the client’s RSSI has suddenly dropped and it does not have a reliable connection with its currently serving AP MLD.

Assuming the client has to perform a direct roam, the method 400 proceeds to block 425 the client selects a roaming target using the list of the prepared neighboring AP MLDs received at block 415. The client can use any of the techniques described in block 315 of method 300 to select a target AP to perform a direct roam.

Once the target AP in the SMD is selected, the method 400 can return to block 405 where the client initiates a roam to the new AP MLD (i.e., the target AP). In this manner, the method 400 can repeat as the client roams to different AP MLDs in the SMD. At each roam (regardless whether the roam was performed directly through a target AP or through the currently serving AP MLD) the client can use method 400 to trigger the new AP MLD to prepare a new set of neighboring AP MLDs for a future direct roam. An updated list of prepared neighboring AP MLDs can be provided to the client so the client can continue to make intelligent direct roaming decisions.

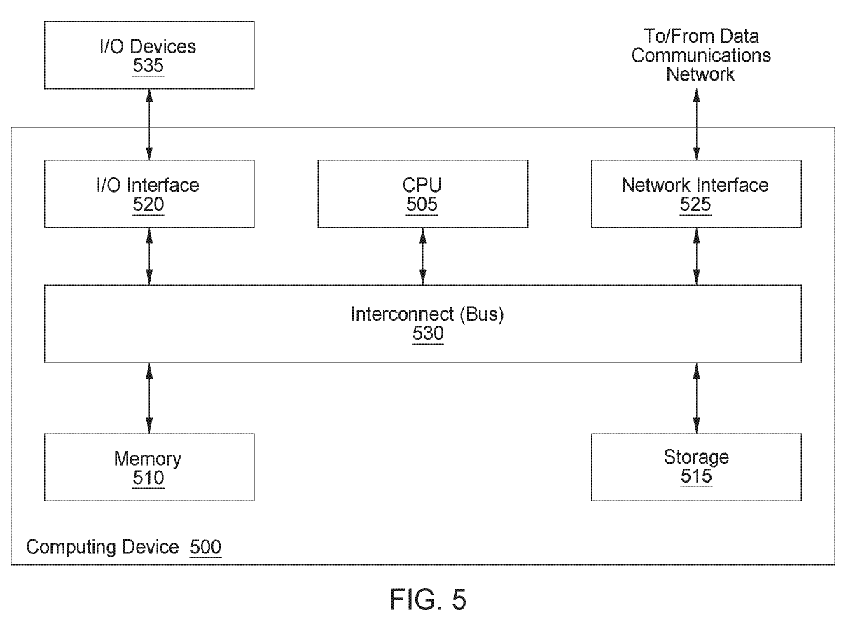

FIG. 5 depicts an example computing device configured to perform various aspects of the present disclosure, according to one embodiment. Although depicted as a physical device, in embodiments, the computing device 500 may be implemented using virtual device(s), and/or across a number of devices (e.g., in a cloud environment). In one embodiment, the computing device 500 corresponds to a network device (e.g., a computing system), such as the AP MLDs 110, 115 or the client 105 (e.g., a non-AP MLD).

As illustrated, the computing device 500 includes a CPU 505 (one or more processors), memory 510 (or memories), storage 515, a network interface 525, and one or more input/output (I/O) interfaces 520. In the illustrated embodiment, the CPU 505 retrieves and executes programming instructions stored in memory 510, as well as stores and retrieves application data residing in storage 515. The CPU 505 is generally representative of a single CPU and/or GPU, multiple CPUs and/or GPUs, a single CPU and/or GPU having multiple processing cores, and the like. The memory 510 is generally included to be representative of a random access memory. Storage 515 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 535 (such as keyboards, monitors, etc.) are connected via the I/O interface(s) 520. Further, via the network interface 525, the computing device 500 can be communicatively coupled with one or more other devices and components (e.g., via a network, which may include the Internet, local network(s), and the like). As illustrated, the CPU 505, memory 510, storage 515, network interface(s) 525, and I/O interface(s) 520 are communicatively coupled by one or more buses 530.

The memory 510 can include software programs or applications for preparing neighboring APs with a client’s roaming context to facilitate future direct ST roams as discussed above in FIGS. 1-4. Although shown as residing in memory 510, in embodiments, the operations of discussed above (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
receiving, at a currently serving access point (AP), a request from a non-AP device to prepare one or more target APs for a future direct roam of the non-AP device directly to one of the one or more target APs, wherein the one or more target APs and the currently serving AP are in a same seamless mobility domain (SMD); and
transmitting, before the non-AP device has requested to roam to one of the one or more target APs and after receiving the request, roaming context associated with the non-AP device to the one or more target APs.

2. The method of claim 1, wherein the request is received as part of the non-AP device associating with the currently serving AP.

3. The method of claim 2, further comprising:
advertising, by the currently serving AP, that the currently serving AP supports preparing target APs for a future direct roam by the non-AP device to the one or more target APs.

4. The method of claim 2, wherein the request is part of an association request frame, a 4-way secure handshake that is part of an association exchange, or a management frame.

5. The method of claim 1, wherein the request from the non-AP device comprises a list of target APs to be prepared for a future direct roam.

6. The method of claim 5, wherein the list of target APs to be prepared for a future direct roam comprises a set of neighbor report elements indicating neighboring APs to prepare.

7. The method of claim 1, wherein the roaming context comprises at least one of: a roaming MAC address the non-AP device will use in the future direct roam, a PMKID identifying a PMK for the non-AP device, a PMKSA including a PMK established with the SMD for the non-AP device, a PTKSA including a PTK established for the non-AP device, or a roaming key established to encrypt roaming request for future direct roam.

8. The method of claim 1, further comprising at least one of:
transmitting from the currently serving AP to the non-AP device a list identifying each of the one or more target APs that was prepared for the future direct roam, or
transmitting from the currently serving AP to the non-AP device an indication that the one or more target APs have been prepared for the future direct roam without specifying a complete list of the one or more target APs.

9. The method of claim 8, wherein the non-AP device selects a roaming target based on the list when performing the future direct roam.

10. The method of claim 9, further comprising:
while the non-AP device is roaming to the one or more target APs or after the non-AP device has roamed to the one or more target APs, receiving at the one or more target APs a new request from the non-AP device to prepare one or more new target APs for a new future direct roam of the non-AP device to one of the one or more new target APs, wherein the one or more new target APs and the one or more target APs are in the same SMD, and
transmitting, before the non-AP device has requested to roam to one of the one or more new target APs and after receiving the new request, roaming context associated with the non-AP device to the one or more new target APs.

11. An access point (AP) comprising:
one or more memories; and
one or more processors communicatively coupled to the one or more memories, wherein the one or more processors are configured, individually or collectively, to perform an operation comprising:
receiving a request from a non-AP device to prepare one or more target APs for a future direct roam of the non-AP device directly to one of the one or more target APs, wherein the one or more target APs and the AP are in a same seamless mobility domain (SMD); and
transmitting, before the non-AP device has requested to roam to one of the one or more target APs and after receiving the request, roaming context associated with the non-AP device to the one or more target APs.

12. The AP of claim 11, wherein the request is received as part of the non-AP device associating with the AP.

13. The AP of claim 12, wherein the operation further comprises:
advertising that the AP supports preparing target APs for a future direct roam by the non-AP device to the one or more target APs.

14. The AP of claim 12, wherein the request is part of an association request frame, a 4-way secure handshake that is part of an association exchange, or a management frame.

15. The AP of claim 11, wherein the request from the non-AP device comprises a list of target APs to be prepared for a future direct roam.

16. The AP of claim 15, wherein the list of target APs to be prepared for a future direct roam comprises a set of neighbor report elements indicating neighboring APs to prepare.

17. The AP of claim 11, wherein the roaming context comprises at least one of: a roaming MAC address the non-AP device will use in the future direct roam, a PMKID identifying a PMK for the non-AP device, a PMKSA including a PMK established with the SMD for the non-AP device, a PTKSA including a PTK established for the non-AP device, or a roaming key established to encrypt roaming request for future direct roam.

18. The AP of claim 11, wherein the operation further comprises at least one of:
transmitting to the non-AP device a list identifying each of the one or more target APs that was prepared for the future direct roam, or
transmitting to the non-AP device an indication that the one or more target APs have been prepared for the future direct roam without specifying a complete list of the one or more target APs.

19. A non-transitory computer readable medium storing instructions that, when executed by one or more processors in a currently serving access point (AP), cause the one or processors to, individually or collectively, perform an operation comprising:
receiving, at the currently serving AP, a request from a non-AP device to prepare one or more target APs for a future direct roam of the non-AP device directly to one of the one or more target APs, wherein the one or more target APs and the currently serving AP are in a same seamless mobility domain (SMD); and
transmitting, before the non-AP device has requested to roam to one of the one or more target APs and after receiving the request, roaming context associated with the non-AP device to the one or more target APs.

20. The non-transitory computer readable medium of claim 19, wherein the request is received as part of the non-AP device associating with the currently serving AP.
